(19) United States
(12) Patent Application Publication
(10) Pub. No.: US 2011/0131652 A1
(43) Pub. Date: Jun. 2, 2011

(54) TRAINED PREDICTIVE SERVICES TO INTERDICT UNDESIRED WEBSITE ACCESSES

(75) Inventors: Stephen R. Robinson, Atlanta, GA (US); Tony Robinson, Atlanta, GA (US); Rob Burson, Atlanta, GA (US)

(73) Assignee: AUTOTRADER.COM, INC., Atlanta, GA (US)

(21) Appl. No.: 12/789,493

(22) Filed: May 28, 2010

Related U.S. Application Data
(60) Provisional application No. 61/182,241, filed on May 29, 2009.

(51) Int. Cl. G06F 11/00; G06F 15/18

(52) U.S. Cl. 726/22; 706/12

(57) ABSTRACT

Webcrawlers and scraper bots are detrimental because they place a significant processing burden on web servers, corrupt traffic metrics, use excessive bandwidth, excessively load web servers, create spam, cause ad click fraud, encourage unauthorized linking, deprive the original collector/poster of the information of exclusive rights to analysis and summarize information posted on their own site, and enable anyone to create low-cost Internet advertising network products for ultimate sellers. A scaleable predictive service distributed in the cloud can be used to detect scraper activity in real time and take appropriate interdictive access up to and including denial of service based on the likelihood that non-human agents are responsible for accesses. Information gathered from a number of servers can be aggregated to provide real time interdiction protecting a number of disparate servers in a network.

### CROSS-REFERENCES TO RELATED APPLICATIONS

This application claims the benefit of provisional application No. 61/182,241 filed May 29, 2009, the contents of which is incorporated herein by reference.

### STATEMENT REGARDING FEDERALLY SPONSORED RESEARCH OR DEVELOPMENT

### Field

The technology herein relates to computer security and to protecting network-connected computer systems from undesired accesses. More particularly, the technology herein is directed to using predictive analysis based on a data set of previous undesirable accesses to detect and interdict further undesired accesses.

### Background and Summary

The world wide web has empowered individuals and enterprises to publish original content for viewing by anyone with an Internet browser and Internet connection from anywhere in the world. Information previously available only in libraries or print media is now readily available and accessible anytime and anywhere for access through various types of Internet browsing devices. One can check mortgage rates on the bus or train ride home from work, view movies and television programs while waiting for a friend, browse apartment listings while relaxing in the park, read an electronic version of a newspaper using a laptop computer, and more.

The ability to make content instantly, electronically accessible to millions of potential viewers has revolutionized the classified advertising business. It is now possible to post thousands of listings on the World Wide Web and allow users to search listings based on a number of different criteria. Cars, boats, real estate, vacation rentals, collectables, personal ads, employment opportunities, and service offerings are routinely posted on Internet websites. Enterprises providing such online listing services often expend large amounts of time, effort and other resources collecting and providing such postings, building relationships with ultimate sellers whose information is posted, etc. Such enterprises provide great value to those who wish to list items for sale as well as to consumers who search the listings.

Unfortunately, some enterprises operating on the Internet do not create any original content of their own. They merely repost content posted by others. Such so-called “clearinghouse” enterprises collect information on as many items as possible, providing its “customers” with information on where those items may be purchased or found. Such “clearinghouse” postings can include artwork, text and other information that has been taken from other sites without authorization or consent. In some cases, hyperlinks on the clearinghouse website take the user directly to web pages of the original poster's website. Other clearinghouse websites provide direct references (e.g., a telephone number or hyperlink) to those who sell the items, or an email tool that allows consumers to email the seller directly—thereby bypassing the original content poster. The clearinghouse website makes money from advertisers. It may also make money by customer referrals.

Typically, the vast amount of information provided by such clearinghouse websites comes from websites operated by others. The clearinghouse operator obtains such information at a fraction of the cost expended by the originator of the information. Since such websites are publicly accessible by consumers, they are also available to the clearinghouse computers. However, clearinghouse computers generally do not obtain the information in the same way the public does (that is, by opening up a web page using a web browser and reading the information off the screen). Rather, clearinghouse computers often use sophisticated devices known as a “webcrawlers,” “spiders” or “bots” to automatically electronically monitor thousands or tens of thousands of web pages on dozens of websites.

Despite somewhat pejorative names, webcrawlers, spiders or “bots” are actually enabling technology for the Internet. For example, modern Internet search engines rely on webcrawlers to harvest web information and build databases users can use to search the vast extent of the Internet. Web search engines such as those operated by Google and Yahoo would not be possible without webcrawlers. However, just as many technologies can be used for either good or ill, webcrawlers can be used by plagiarists as well as by those who want to make the web more user-friendly.

Generally speaking, web crawler or spider computers enter a web server electronically through the home page and make note of the URL's (universal resource locators, which are types of electronic addresses) of the web pages the web server serves. The webcrawler or spider then methodically extracts the electronic information from the pages (containing e.g., the URL, photos, descriptions, price, location, etc.). Once the extraction process is completed, the original copied web page is often or usually discarded. Legitimate search engines may retain only indexing information such as keywords.

In contrast, plagiarists often retain and repost much or all of the content their bots harvest. Often, the copied content is posted without credit or attribution. The more valuable the content, the more likely plagiarists will expend time and effort to find and repurpose such content.

On a more detailed technical level, plagiaristic webcrawlers often perform an operation known as “web scraping” or “page scraping.” “Scraping” refers to various techniques for extracting content from a website so the content can be reformatted and used in another context. Page scraping often extracts images and text. Web scraping often works on the underlying object structure (Document Object Model) of the language the website is written in (e.g., HTML and JavaScript). Either way, the “scraping bot” copies content from existing websites that is then used to generate a so-called “scraper site.” The plagiarized content is often used to draw traffic and associated advertising revenue to the scraper site.

The detrimental effects of malicious bot activities are not limited to redistribution of content without authorization or permission. For example, such bots can:
place a significant processing burden on web servers—sometime so much that consumers are denied service
corrupt traffic metrics
use excessive bandwidth
excessively load web servers
create spam
cause ad click fraud
encourage unauthorized linking
provide automated gaming
deprive the original collector/poster of the information of exclusive rights to analysis and summarize information posted on their own site
enable anyone to create low-cost Internet advertising network products for ultimate sellers
more.

Because this plagiarism problem is so serious, people have spent a great deal of time and effort in the past trying to find ways to stop or slow down bots from scraping websites. Some such techniques include:

Blocking selected IP addresses known to be used by plagiarists;

If the bot application is well behaved, it will adhere to entries of a “robots.txt” exclusion protocol file in a top level directory of the target website (unfortunately, more malicious or plagiaristic bots usually ignore “robots.txt” entries);

Blocking bots that don't declare who they are (unfortunately, malicious or plagiaristic bots usually masquerade as a normal web browser);

Blocking bots that generate excess using traffic monitoring techniques;

Verifying that a human is accessing the site by using for example a so-called “Captcha” (“Completely Automated Public Turing test to tell Computers and Humans Apart”) challenge-response test or other question that only humans will know the answer to and be able to respond to;

Injecting a cookie during loading of login form (many bots don't understand cookies);

Other techniques.

Unfortunately, the process of detecting and interdicting scraper bots can be somewhat of a tennis match. Malicious bot creators are often able to develop counter-measures to defeat virtually any protection measure. The more valuable the content being scraped, the more time and effort a plagiarist will be willing to invest to copy the content. In addition, there is usually a tradeoff between usability and protection. Having to open ten locks before entering the front door of your house provides lots of protection against burglars but would be very undesirable if your hands are full of groceries. Similarly, consumer websites need to be as user-friendly as possible if they are to attract a wide range of consumers. Use of highly protective user interface mechanisms that slow scraper bots may also discourage consumers.

Some in the past have attempted predictive analysis to help identify potential scrapers. While much work has been done to solve these difficult problems, further developments are useful and desirable.

The technology herein provides intelligent, predictive solutions, techniques and systems that help solve these problems.

In accordance with one aspect of exemplary illustrative non-limiting implementations herein, a predictive analysis based on artificial intelligence and/or machine learning is used to distinguish, with a high degree of accuracy, between human consumers and automated scraper threats that may be masquerading as human consumers.

In one exemplary illustrative non-limiting implementation, website accesses are analyzed to recognize patterns and/or characteristics associated with malicious or undesirable accesses. Such machine learning is used at least in part to predict whether future accesses are malicious and/or undesirable. The machine learning can be conducted in real time, or based on historical log and other data, or both. Such intelligence can be used for example to provide focused malicious access interdiction to force access of posted information through the same mechanism (e.g., application programming interface) that consumers use.

In one exemplary illustrative non-limiting implementation, interdiction is (a) at least in part real-time, (b) automatic, (c) rules-driven, (d) communicated via alerts, and (e) purposeful.

One exemplary illustrative implementation analyzes a log file or other recording representing a history of previous accesses of one or more websites. Some of this history can have been gathered recently and analyzed in real time or close to real time. Other history can have been gathered in the past, before the interdiction system was even installed or contemplated. The analysis can be completely automatic, human guided or a combination. A goal of the analysis is to recognize previous accesses that were undesired or malicious. Upon classifying a site's visitor as exhibiting undesirable behavior, relevant information about any malevolent visitor is made available to a database. This information is used to create another online service such as a real-time DNS blacklist. The online service can be made available over the Internet or other network.

In more detail, the result of the data analysis can be used to:
create a real-time scraper database or DNS Blacklist
continued Analysis, use in Machine Learning, and pattern recognition
identify ‘signatures’ of particular, specific ‘scraper’ and their software
generate detailed Statistical Reports For Site Owners
other.

Scraper remediation (from low-impact to high-impact interdiction) can include for example:
No interdiction, but a simple logging of the client's information as a potential scraper;
Introduction of an investigative ‘bug’ or ‘tag’ via javascript onto subsequent page requests from the potential scraper;
Introduction of significant change in page content or page structure to the potential scraper;
Imposing a limitation on requests/second on the potential scraper;
Introduction of a ‘web tracking device’ or hidden content (e.g. a globally unique text sequence) into the page's content that can be uniquely identified via a search engine;
Display of a ‘captcha’ page (page requiring human interpretation and action) to the scraper;
Custom page displayed requesting registration or alternative means of identification (phone, etc.);
Denial of access;
Other.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 shows, in the context of an exemplary illustrative non-limiting implementation, multiple instances of a predictive service that services requests from multiple independent websites;

FIG. 2 shows an exemplary illustrative non-limiting example deployment instance for a single, independent web site or web host;

FIG. 3 shows an exemplary illustrative non-limiting implementation process for training a model to recognize unacceptable website visitor behavior in order to build a classifier; and

FIG. 4 shows an exemplary illustrative non-limiting implementation process for using a model or classifier to identify unacceptable website visitors in real time.

### DETAILED DESCRIPTION

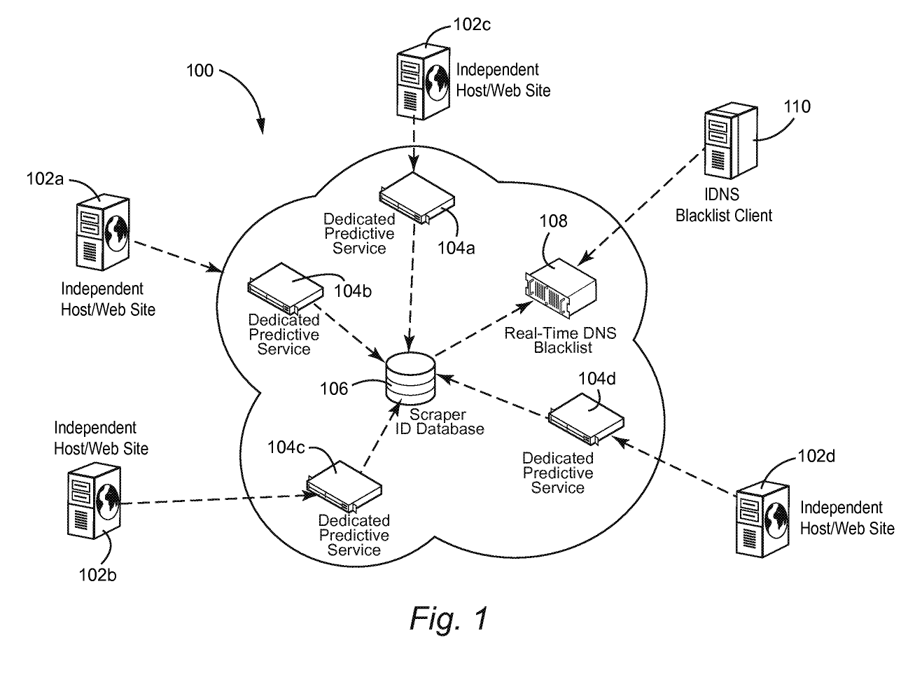

FIG. 1 shows an exemplary illustrative non-limiting architecture 100 providing multiple instances of a predictive service 104. Architecture 104 may service prediction requests from several independent hosts and/or websites 102a, 102b, etc. Upon classifying a site's visitors as exhibiting undesirable behavior (or not), the relevant information about any malevolent visitor is made available to a scraper ID database 106. This information is used to create another online service such as a real-time DNS blacklist 108 coordinating with a DSN blacklist client 110. The predictive services can be made available via the Internet (as indicated by the “cloud” in FIG. 1) or any other network.

In more detail, one or a plurality of predictive services 104 are used to monitor accesses of associated web servers 102. For example, predictive service 104a may be dedicated or assigned to predicting characteristics of accesses of website 102a, predictive service 104b may be dedicated or assigned to predicting characteristics of accesses of website 102b, etc. There can be any number of predictive services 104 assigned to any number of websites 102. Thus for example each predictive service could be assigned to plural websites, or each website could be assigned to plural predictive services. Providing a distributed network of predictive services assigned to associated distributed websites allows for a high degree of scalability. Predictive services 104a, 104b, 104c can be co-located with their associated website (e.g., software running on the same server as the webserver) or they could be located remotely, or both.

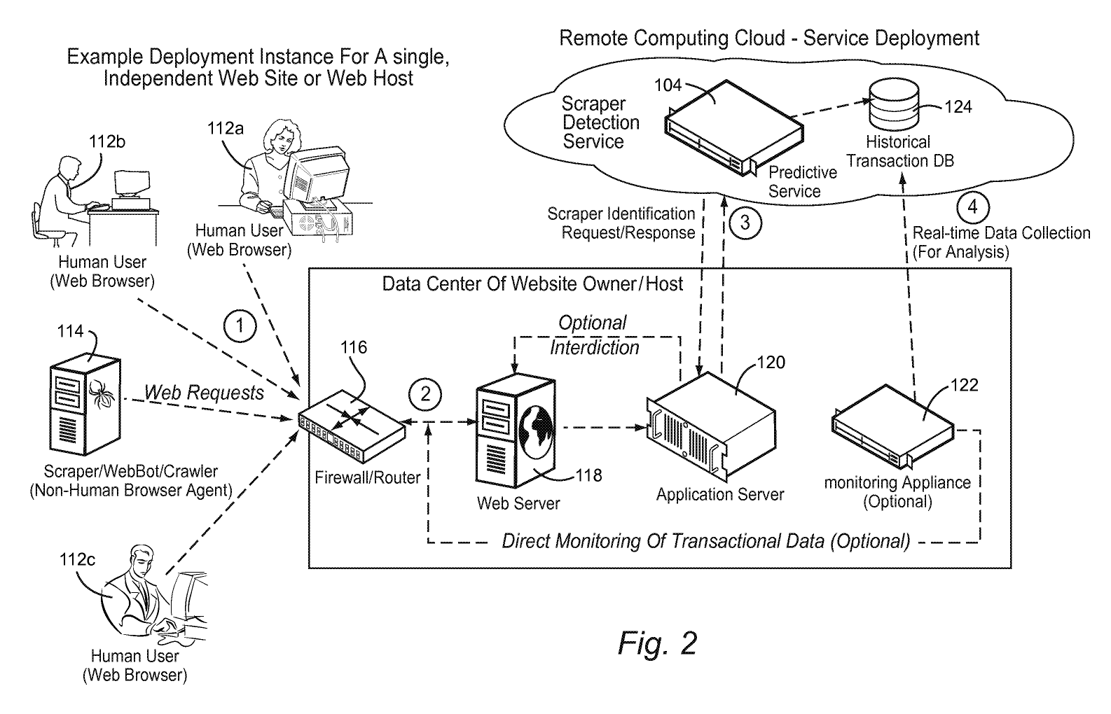

As mentioned above, predictive services 104 are each responsible for monitoring access traffic on one or more associated websites 102 to detect malicious or other undesirable accesses. FIG. 2 shows example monitoring for one predictive service 104 in more detail. In this example, a conventional web server 118 is accessed through a conventional firewall 116 by human users 112 using web browsers. This is a typical server configuration for hosting a website, where the website's web server 118 is processing the incoming web requests and communicating with an application server 120 which provides the site's business logic (i.e., decision making). Note that webserver 118 can comprise multiple webservers or a network of computers, and may host one or multiple websites.

In conventional fashion, these human users 112 operate computing devices providing user interfaces including for example displays and other output devices; keyboards, pointing devices and other input devices; and processors coupled to memory, the processors executing code stored in the memory to perform particular tasks including for example web browsing. Such web browsers can be used to navigate web pages that the web server 118 then serves to the browser. For example, the human users' 112 web browsers generate http web requests including URL's and other information and send these requests wirelessly or over wired connections over the Internet or other network to the web server 118. The web server 118 responds in a conventional fashion by sending web pages in the form of html, xml, Java, Flash, and/or other information back to the IP addresses of requesting user browsers. In the case of a consumer oriented website, is desirable that this human-driven process be interfered with as little as possible.

Meanwhile, however, a scraper/webbot/webcrawler computer or other non-human browser agent 114 is also shown sending webserver 118 web requests. Thus, in this particular example, FIG. 2 shows several (acceptable) human users 112 visiting the website (making web requests) along with a single, mechanized visitor or “scraper” which is collecting the site's content in an unauthorized manner. The non-human agent 114 masquerades as and identifies itself as a browser, so generally speaking, explicit identifiers the non-human agent provides cannot be used to distinguish it from a human-operated browser. The http requests sent by the non-human agent 114 typically are indistinguishable from http requests a human-operated browser sends. A worthwhile objective is to nevertheless reliably distinguish between the accesses initiated by humans 112 and the accesses initiated by non-human agent 114 so that the non-human browser 114 can be detected and appropriate action (including interdiction) can be taken.

To this end, additional rules-based logic provided by application server 120 and an optional monitoring appliance 122 may be placed in the computer data center of the website owner/host and thus co-located with or remotely located from web server 118. The application server 120 (which may be hardware and/or software) communicates in the exemplary illustrative non-limiting implementation over the Internet or other communications path with a scraper detection predictive service 104. The application server 120 communicates with webserver 118 and receives sufficient information from the webserver 118 to discern characteristics about individual accesses as well as about patterns of accesses. For example, the application server 120 is able to track accesses by each concurrent user accessing webserver 118. The application server 120 can deliver the most recent “request data” to the predictive service 104, in order to obtain a prediction. It can report IP addresses, access pattern characteristics and other information to scraper detection service 104.

Scraper detection service 104 (which can be located with application server 120, located remotely from the application server, or distributed in the cloud) provides software/hardware including a trained model that can identify scrapers. Predictive service 104 analyzes the information reported by application server 120 and predicts whether the accesses are being performed by a non-human browser agent 114. If scraper detection service 104 predicts that the accesses are being performed by a non-human browser agent 114, it notifies application server 120. Application server 120 can responsively perform a variety of actions including but not limited to:
No interdiction, but a simple logging of the client's information as a potential scraper;
Introduction of an investigative ‘bug’ or ‘tag’ via javascript onto subsequent page requests from the potential scraper;
Introduction of significant change in page content or page structure to the potential scraper;
Imposing a limitation on requests/second on the potential scraper;
Introduction of a ‘web tracking device’ or hidden content (e.g. a globally unique text sequence) into the page's content that can be uniquely identified via a search engine;
Display of a ‘captcha’ page (page requiring human interpretation and action) to the scraper;
Custom page displayed requesting registration or alternative means of identification (phone, etc.);
Denial of access
Other.

Predictive server 104 performs its predictive analysis based on an historical transaction database 124. This historical database 124 can be constructed or updated dynamically for example by using a monitoring appliance 122 to monitor transaction data (requests) as it arrives from firewall/router 116 and is presented to web server 118. The monitoring appliance 122 can provide on-site traffic monitoring to deliver real-time data to the historical database 124 for use in improving the predictive model and enhancing the currently running predictive service. The monitoring appliance 122 can report this transaction data to historical database 124 so it can be used to dynamically adapt and improve the predictive detection performed by predictive service 104.

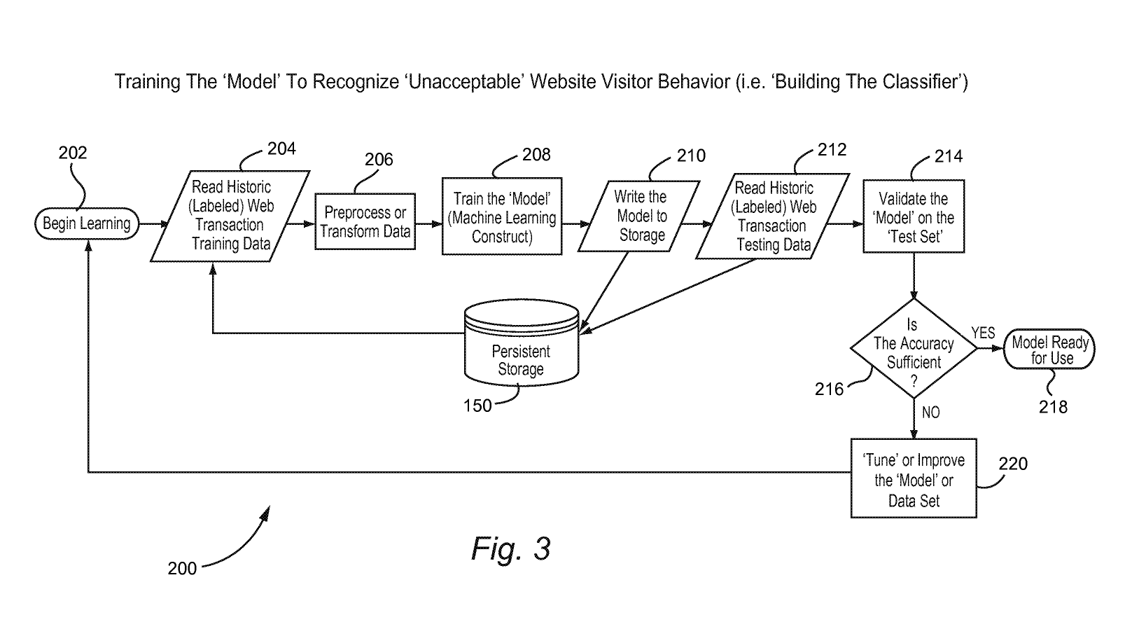

FIG. 3 shows an example suitable process for training the predictive service model to recognize unacceptable website visitor behavior (i.e., to build a classifier). Machine learning and artificial intelligence techniques are used to teach this classifier model in the exemplary illustrative non-limiting implementation. In this particular example shown, historical (labeled) transaction training data is read from a mass storage device (block 204) and is preprocessed and/or transformed (block 206). This training data is then used to train the model using machine learning techniques (block 208). The model training can be human guided and/or the historical web data can be labeled by a human who has analyzed the data after the fact with a high degree of certainty as to which transactions constituted non-human accesses and which ones constituted human accesses.

For example, most non-human scraper accesses tend to access a higher number of pages and a shorter amount of time than any human access. On the other hand, there are fast human users who may access a large number of pages relatively quickly, and some non-human agents have been programmed to limit the number of pages they access during each web session and to delay switching from one page to the next, in order to better masquerade as a human user. However, based on IP addresses or other information that can be known with certainty after the fact, it is possible to distinguish between such cases and know which historical accesses were by a human and which ones were by a non-human bot. This kind of information can be used to train the model as shown in block 208.

Once the model is generated, it can be written to storage 150 (block 210). Historical web transaction testing data can be again read (block 212) and the model can be validated on the test set (block 214) to ensure the model has learned the test set. If the accuracy is sufficient (“yes” exit to decision block 216), the model is declared to be ready for use (block 218). If the accuracy is not yet sufficient (“no” exit to decision block 216), the process shown can be iterated on additional test data sets to tune or improve the model or data set (block 220). The learning process shown can continue even after the model is declared to be sufficiently accurate for use, so the model can dynamically adapt to changing techniques used by non-human bots to access websites.

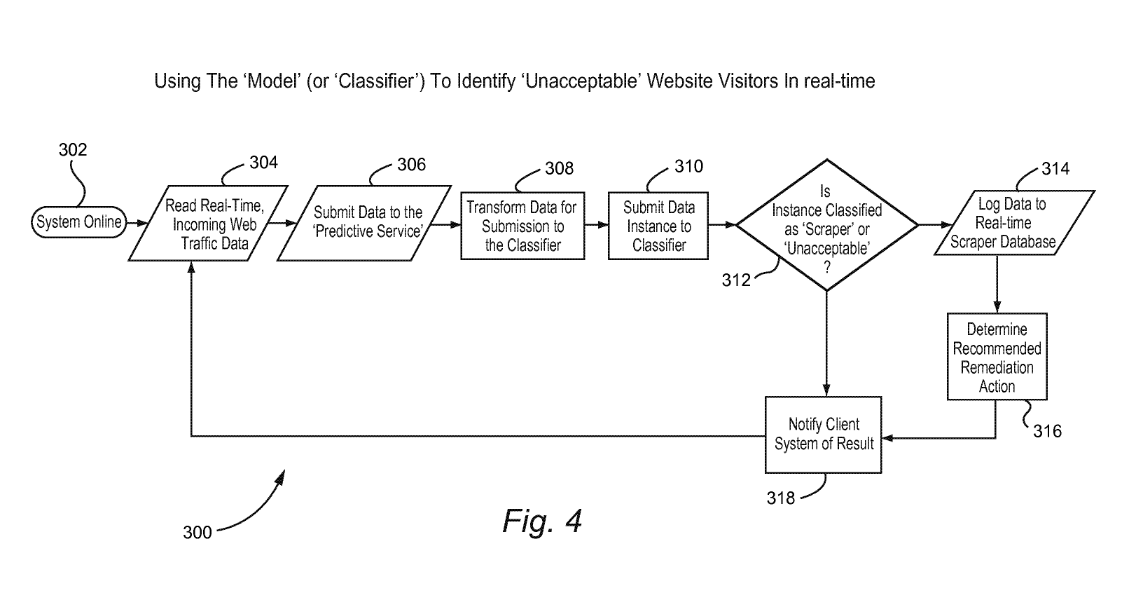

FIG. 4 shows a suitable non-limiting example implementation of a process for using the model or classifier to identify unacceptable website visitors in real time. In the example shown, real-time incoming web traffic data is read (block 304) and submitted to the predictive service (block 306). The data is transformed for submission to the classifier (block 308) and data instances are submitted to the classifier (block 310). If the predictive service determines that an instance is not a scraper or is otherwise acceptable (“no” exit to decision block 312), then the client is notified (block 318) that all is well. If the predictive service determines, on the other hand, that an instance is classified as a scraper or is otherwise find to be unacceptable (“yes” exit to decision block 312), the data is logged in real time to a scraper database (block 314) and the predictive service 102 determines a recommended remedial action (block 316). The client is notified of this result (block 318) and may take the appropriate remedial action to confound the scraper, ensure it receives only the information to which it is entitled, or is stopped in its tracks.

Since the predictive service 102 is merely predicting, the prediction is not 100% accurate. There may be some instances in “grey” areas where a heavy human user is mistaken for a bot or where a human-like bot is mistaken for a real human. Therefore, the type of interdiction used may in some examples be based on a predictive certainty factor that predictive service 102 may also generate. For example, if the predictive service 102 is 99% certain that it is seeing a non-human agent, then interdiction factors can be relatively harsh or extreme. On the other hand, if the predictive service 102 is only 50% certain, then interdiction may be less radical to avoid alienating human users. For example, burdens such as presenting a “Captcha” can be imposed on suspected non-human agents that would be easy (if not always convenient) for humans to deal with or respond to but which may be difficult or impossible for bots to handle.

Additionally, the predictive analysis described above can be used to identify signatures of particular scraping sites. Each unique piece of scraping software may have its own characteristic way of accessing webpages, based on the particular way that the bot has been programmed. Such a signature can be detected irrespective of the particular IP address used (IP addresses can change). Signature detection can be used to identify particular entities that make a business out of scraping other people's content without authorization. Developing and reporting such signatures can be useful service in itself.

For example, in one exemplary illustrative non-limiting implementation, the predictive analysis and associated components that perform it can be located remotely from but used to protect a number of websites. In one implementation, the predictive analysis architecture as shown in FIG. 1 can be distributed throughout the cloud or other network and used to protect multiple websites each having an associated local monitoring and/or logging capability. The predictive analysis can leverage the information gathered from one website (consistent with any privacy concerns) to assist it in recognizing scraping behavior on other websites. Thus, by the time a scraper bot reaches a particular website, the predictive analysis may already have experience with the scraper bot by observing its behavior on other websites, and can immediately interdict without having to learn anything at all. Similar to virus protection offerings, this functionality provides potential business opportunities for subscription or other services that extend beyond the single enterprise.

While the technology herein has been described in connection with exemplary illustrative non-limiting implementations, the invention is not to be limited by the disclosure. For example, while an emphasis in the description above has been to detect scraper bots, any other type of undesired accesses could be detected (e.g., spam, any type of non-human interaction, certain destructive or malicious types of human interaction such as hacking, etc.) The invention is intended to be defined by the claims and to cover all corresponding and equivalent arrangements whether or not specifically disclosed herein.

We claim:

1. In a computer arrangement connected to a network, said computer arrangement allowing access by other computers over the network, a method of reducing the impact of undesired server accesses comprising:
(a) monitoring accesses to at least one server;
(b) analyzing said monitored accesses based at least in part on a classifier predictive model, to predict the likelihood that accesses are being made by non-human agents; and
(c) if said analyzing predicts that monitored accesses are possibly being made by non-human agents, performing at least one interdiction action in substantially real time response to said predicted likelihood.

2. The method of claim 1 wherein said monitoring is performed on a first server to develop said predictive model, and said performing is performed on a second server different from said first server to interdict upon recognizing that said non-human agent is attacking said second server.

3. The method of claim 1 wherein said monitoring is performed substantially in real time.

4. The method of claim 1 wherein said interdiction action comprises one of the set consisting of (a) logging of the client's information, (b) introducing an investigative ‘bug’ or ‘tag’ via javascript onto subsequent page requests, (c) introducing a significant change in page content or page structure, (d) imposing a limitation on requests/second, (e) introducing a ‘web tracking device’ or hidden content into the page's content that can be uniquely identified via a search engine, (f) displaying a page requiring human interpretation and action, (g) displaying a page displayed requesting registration or alternative means of identification, and (h) denial of access.

5. The method of claim 1 wherein said interdiction action comprises imposing a burden on predicted non-human agents that are not imposed on humans.

6. The method of claim 1 further including training the classifier predictive model based on historical information obtained from previous website accesses.

7. The method of claim 6 wherein said training is based on historical information gathered from plural different websites.

8. A computer system for allowing access to at least one server over a network while reducing the impact of undesired server accesses, comprising:
a network connection;
at least one server connected to the network connection;
a monitoring appliance that monitors accesses to the at least one server substantially in real time;
said monitoring appliance including means for analyzing said monitored accesses based at least in part on a classifier predictive model, to predict the likelihood that accesses are initiated by non-human agents; and
means for automatically selecting at least one interdiction action based on said likelihood.

9. A data processing system comprising:
a machine learning component that uses historical access data to train a predictive model; and
at least one online predictive service device coupled to a host website, said predictive service device operating in accordance with said trained predictive model, said predictive service device using said trained predictive model to predict whether an access(es) to the host website is made by other than a human operating a web browser and in response to a prediction that the access(es) is made by other than a human operating a web browser, changes the manner in which the host website responds to said access(es).

10. A website monitoring service comprising:
at least one predictive model trained on historical data;
plural predictive service devices associated with plural corresponding websites, said predictive service devices performing online monitoring of said associated corresponding websites and reporting monitoring results; and
a centralized database in communication with said plural predictive service devices, said centralized database using said reported results to further train said predictive model,
wherein said plural predictive service devices predict undesired accesses to said associated corresponding websites and recommend interdiction.

11. The service of claim 10 wherein said predictive service devices detect non-human agent accesses as undesired accesses.

12. A website monitoring service comprising:
at least one predictive model trained on historical data at least some of which was collected before said monitoring service is instituted on a given server;
plural monitoring computers associated with plural corresponding servers, said monitoring computers performing online monitoring of said associated corresponding servers and reporting monitoring results over a computer network;
a distributed predictive modeling agent in communication with said plural monitoring computers, said distributed predictive modeling agent using said reported results to further train said predictive model,
wherein said distributed predictive modeling agent predicts undesired accesses to monitored servers and recommends interdiction, and
wherein said monitoring and interdiction recommending is offered on a fee basis to operators of said servers, and information said predictive modeling agent harvests from a first server is used to predict or detect undesired accesses of a second server different from said first server.

13. The service of claim 12 wherein said at least some of said servers comprise web servers.

14. The service of claim 12 wherein said undesired accesses include page scraping.
